(19) United States
(12) Patent Application Publication
(10) Pub. No.: US 2009/0056592 A1
(43) Pub. Date: Mar. 5, 2009

(54) COMBINED CARGO CARRIER AND PORTABLE TABLE

(75) Inventors: Stephen W. Threet, North Augusta, SC (US); Terry Smith, North Augusta, SC (US)

Correspondence Address: DORITY & MANNING, P.A., POST OFFICE BOX 1449, GREENVILLE, SC, 29602-1449, US

(73) Assignee: Everthere Carriers, LLC, Martinez, GA (US)

(21) Appl. No.: 11/848,472

(22) Filed: Aug. 31, 2007

(51) Int. Cl. B60R 9/00; A47B 85/00

(52) U.S. Cl. 108/11; 224/499

(57) ABSTRACT

The present invention pertains generally to a combination cargo carrier for a vehicle and portable table. The cargo carrier may include a base connected to one or more wings that have a retracted position that occupies a smaller volume than an extended position. A stand removably connects to the cargo carrier to form the portable table. In particular embodiments, the cargo carrier may also include a cargo bag having a collapsible frame.

### BACKGROUND OF THE INVENTION

The present invention describes and enables a combined cargo carrier and portable table. It is known in the art to attach a platform to a vehicle for carrying cargo and increasing the carrying capacity of the vehicle. The platform generally consists of a rectangular surface that attaches to a trailer hitch or receiver on the vehicle. In this manner, the platform provides additional carrying capacity for the vehicle.

When additional carrying capacity is not needed, it is desirable to store the platform in a convenient, readily accessible location. One solution is to remove the platform from the vehicle and store the platform until needed. Although this solution restores the vehicle to its original length, the platform is generally too bulky to store inside the vehicle, and storing the platform separate from the vehicle limits the accessibility of the platform. Another solution, as shown in U.S. Pat. Nos. 4,744,590; 6,382,486; and 6,513,690, is to fold the platform toward the vehicle and leave the platform attached to the vehicle in this folded position. Although this solution ensures that the platform is readily accessible, the platform still adds some length to the vehicle. In addition, the folded platform may be aesthetically undesirable, or it may interfere with the vehicle's trunk or tailgate operation.

U.S. Pat. No. 7,246,733, which is incorporated in its entirety for all purposes, discloses and teaches yet another solution. In this solution, the platform includes one or more wings that fold up to occupy a smaller volume for storage. In this manner, the platform can be removed, folded up, and conveniently detached and stored.

U.S. Patent Publication 2007/0164069, which is incorporated in its entirety for all purposes, discloses and teaches yet another solution. In this solution, the carrier further includes a cargo bag used in conjunction with the carrier. The cargo bag protects the cargo from the environment. In addition, the cargo bag may serve as a carrying or storage bag for the carrier when the carrier is stored.

Based on these and other prior art devices, the need exists for an improved cargo carrier that can increase the carrying capacity for a vehicle, that can be conveniently stored when not in use, that protects the cargo from the environment, and/or that has increased functionality in addition to carrying cargo.

### SUMMARY OF THE INVENTION

Objects and advantages of the invention are set forth below in the following description, or may be obvious from the description, or may be learned through practice of the invention.

One embodiment of the present invention is directed to a portable table that includes a cargo carrier and a stand removably connected to the cargo carrier. The cargo carrier includes a base that defines a planar carrying surface and a first wing moveably connected to the base and having a retracted position that occupies a smaller volume than an extended position. The cargo carrier is configured to carry cargo when the first wing is in the extended position.

In particular embodiments, the cargo carrier may further include a second wing moveably connected to the base and opposite the first wing, wherein the first and second wings are on opposing sides of the base. The first and second wings each may include an inner section proximate to the base and an outer section moveably attached to the inner section and separated from the base by the inner section in the extended position. For at least one of the first and second wings, the outer section may reside within the inner section in the retracted position. Alternatively, the base may include a locking mechanism for locking the first wing in the retracted position.

In other particular embodiments, the stand may include a closed receiver. Alternatively, the portable table may include a cargo bag removably attached to the cargo carrier, and the cargo bag may include a collapsible frame.

Another embodiment of the present invention is directed to a combined cargo carrier for a vehicle and portable table. The combined apparatus includes a base, a first wing moveably connected to the base, and a second wing moveably connected to the base and opposite the first wing. Each of the first and second wings has an extended position and a retracted position. The cargo carrier is configured to be extendable substantially perpendicular to the length of the vehicle. A stand is removably connected to at least one of the base, first wing, or second wing.

In particular embodiments, the first and second wings may be transverse to the base in the retracted position. Alternatively, the cargo carrier may occupy a smaller volume when at least one of the first or second wings is in the retracted position than when both the first and second wings are in the extended position.

Yet another embodiment of the present invention is directed to a portable table that includes a cargo carrier and a stand removably connected to the cargo carrier. The cargo carrier includes a base and a first wing moveably connected to the base and having an extended position, a partially retracted position, and a retracted position. The cargo carrier occupies a smaller volume when the first wing is in the retracted position than when the first wing is in the extended position.

In particular embodiments, the first wing is transverse to the base in the retracted position. In other particular embodiments, the cargo carrier further includes a second wing moveably connected to the base and opposite the first wing.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an embodiment of a cargo carrier in the extended position;

FIG. 2A is an elevational view in cross section of an embodiment of a support plate taken along line 2A-2A in FIG. 1;

FIG. 2B is an elevational view in cross section of another embodiment of a support plate similar to the support plate in FIG. 2A;

FIG. 2C is an elevational view in cross section of yet another embodiment of a support plate similar to the support plate in FIG. 2A;

FIG. 3 is a close-up perspective view of the cargo carrier depicted in FIG. 1;

FIG. 4 is a perspective view of the cargo carrier depicted in FIG. 1 in the intermediate position;

FIG. 5 is a perspective view of the cargo carrier depicted in FIG. 1 in the retracted position;

FIG. 6 is a perspective view of the cargo carrier depicted in FIG. 1 with an embodiment of a cargo bag installed;

FIG. 7 is a perspective view of an embodiment of a collapsible frame;

FIG. 8 is a perspective view of the collapsible frame shown in FIG. 7 in the collapsed position;

FIG. 9 is a perspective view of an embodiment of a stand; and

FIG. 10 is a perspective view of the cargo carrier depicted in FIG. 1 installed on the stand depicted in FIG. 9.

### DETAILED DESCRIPTION OF THE DISCLOSURE

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention relates to a combination cargo carrier and portable table. The cargo carrier attaches to a vehicle to increase the carrying capacity of the vehicle. When not in use, the cargo carrier folds up for convenient detachment and storage. In addition, the cargo carrier may be attached to a stand to form a portable table.

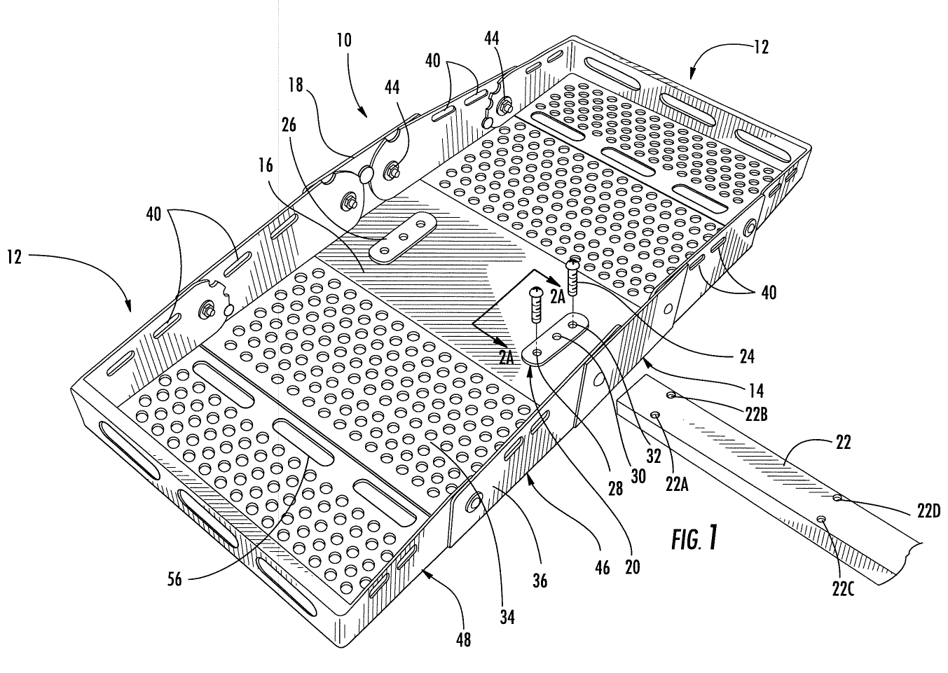

FIG. 1 illustrates a perspective view of a cargo carrier 10 constructed according to one embodiment of the present invention. The cargo carrier 10 generally includes wing assemblies 12 pivotally connected to opposing sides of a base 14.

The base 14 provides a sturdy foundation for attaching the wing assemblies 12 to the carrier 10 and for connecting the cargo carrier 10 to the vehicle. The base 14 may be made of metal, plastic, fiberglass, or a combination thereof, depending on the particular uses and needs. The base 14 may include a flat surface 16, one or more sides 18, and a mount 20.

The flat surface 16 provides a portion of the surface area for carrying a desired cargo (not shown). The sides 18 provide a perimeter for the cargo carrier 10 to aid in holding the cargo in the cargo carrier 10 or securing the cargo to the cargo carrier 10. The flat surface 16 and sides 18 may be solid, as shown in FIG. 1, or may include perforations or holes to reduce the weight of the cargo carrier 10.

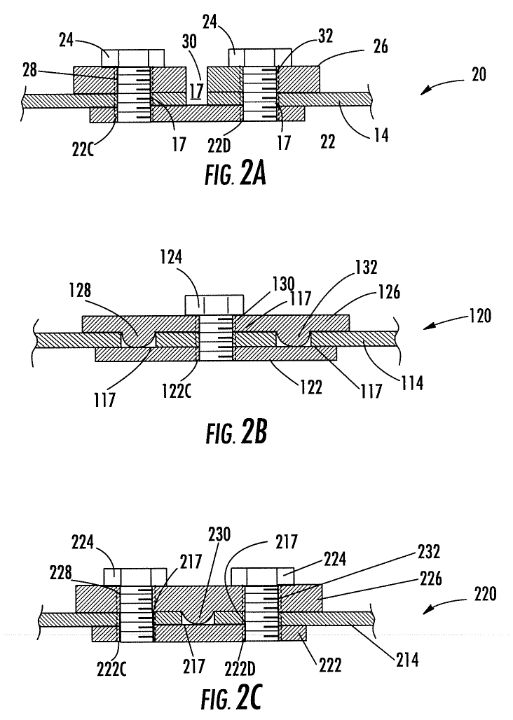

The mount 20 provides structure for attaching the cargo carrier 10 to vehicles having various sized receivers. For instance, with reference to one embodiment shown in FIGS. 1 and 2A, the mount 20 may include a drawbar 22 bolted to the base 14 with connection devices 24 such as through-bolts, U-bolts, screws, or similar devices. The mount 20 may further include a support plate 26 with knock-out holes 28, 30, 32 to accommodate drawbars of varying sizes. As shown, if the drawbar 22 has a 2 inch width, for instance, then two through-bolts 24 may be threaded through the outer two knock-out holes 28, 32, through an aperture 17 in the base 14 and through respective drawbar apertures 22C, 22D to attach the drawbar 22 to the base 14. In this manner, the mount 20 can accommodate drawbars of varying widths.

Alternate embodiments of the mount 20 may include equivalent structure for attaching the cargo carrier 10 to the vehicle. For example, the mount 20 may include a square collar or mounting sleeve (not shown) attached to the underside of the base 14 to receive the drawbar 22. The square collar or mounting sleeve receives the drawbar 22, and a clevis pin, cotter pin, bolt, or other suitable structure secures the square collar or mounting sleeve to the drawbar 22. In still further embodiments, the mount 20 may be a clamp, vice grip, or other structure more suitable for securely engaging the cargo carrier 10 to a ball-type trailer hitch.

In an alternative embodiment of a mount 120, in some ways similar to that of FIG. 2A, a drawbar 122 is shown in FIG. 2B having a 1¼ inch width. As shown, a single through-bolt 124 is threaded through a center knock-out hole 130 of a support plate 126, through an aperture 117 in a base 114 and through a center hole 122C of the drawbar 122 to attach the drawbar 122 to the base 114. As further shown, two projections or protrusions 128, 132 are formed on the support plate 126 to help secure the support plate 126 to the base 114. More particularly, the protrusions 128,132 extend into respective apertures 117 of the base 114 to help anchor the support plate 126 to the base 114. Thus, when the through-bolt 124 is attached as described above, the protrusions 128,132 prevent the support plate 126 from rotating about the through-bolt 124.

In yet another embodiment of a mount 220 shown in FIG. 2C, which in some ways is similar to the mount 20 of FIG. 2A, the mount 220 may include a support plate 226 with two knock-out holes 228, 232 and a protrusion 230 to accommodate drawbars of varying sizes. As shown, the exemplary drawbar 222 has a 2 inch width. Therefore, two through-bolts 224 are threaded through the outer two knock-out holes 228, 232, through respective apertures 217 in a base 214 and through respective drawbar apertures 222C, 222D. Also shown, the protrusion 230 extends into one of the apertures 217 to attach the drawbar 222 to the base 214. The skilled artisan will instantly recognize that aspects of the embodiments shown in FIGS. 2A-2C can be modified and interchanged to accommodate various sizes of drawbars and cargo carriers. Further, additional apertures and holes in a variety of shapes and sizes can be provided; thus, the invention is not limited to the illustrated examples.

With further reference to FIG. 1, the wing assemblies 12 provide the remainder of the surface area for carrying cargo. As shown, the wing assemblies 12 may be symmetric, or one wing assembly may be larger than the other. Furthermore, the wing assemblies may provide the majority of the surface area for carrying cargo, as shown in FIG. 1, or the base 14 may provide the majority of the surface area for carrying cargo in alternate embodiments.

In the embodiment shown in FIG. 1, each wing assembly 12 may include a flat surface 34 and vertical sides 36, and horizontal support bars 38. The flat surface 34, vertical sides 36, and horizontal support bars 38 may be separate components that are bolted, welded, or fastened together. Alternately, the flat surface 34, vertical sides 36, and horizontal support bars 38 may be a unitary structure pressed or molded from a sheet of metal, plastic, fiberglass, or a combination thereof, depending on the particular uses and needs.

The flat surface 34 extends between the vertical sides 36 and provides additional surface area for carrying the desired cargo. The flat surface 34 may be a solid piece of material or may include perforations or holes, such as with extruded metal, to reduce the weight of the cargo carrier 10.

The vertical sides 36 define the perimeter of the cargo carrier 10 and may provide additional structural support for the wing assemblies 12. The vertical sides 36 may include slits 40 or holes to provide attachment points for strapping articles to the cargo carrier 10 and to further reduce the weight of the cargo carrier 10.

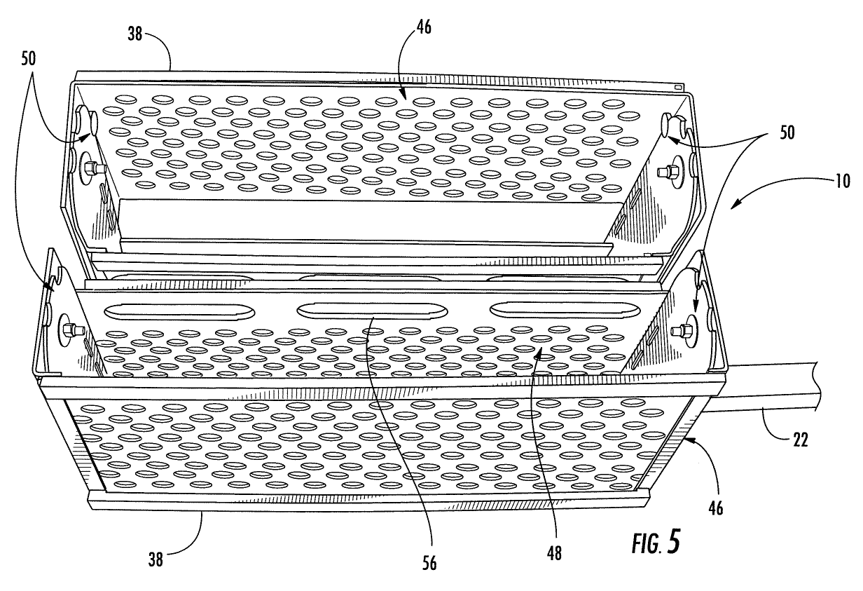

The horizontal support bars 38 (seen most clearly in FIG. 5) extend between the vertical sides 36 and provide structural support for the flat surface 34. The horizontal support bars 38 may attach directly to the vertical sides 36 using rivets, bolts, tack welds, or similar suitable methods. Alternately, the horizontal support bars 38 may attach to a support flange on the vertical sides 36. The flat surface 34 then attaches to the horizontal support bars 38 and/or vertical sides 36 in similar fashion. It should be understood by one of ordinary skill in the art that alternate embodiments within the scope of the present invention may employ other methods for connecting the flat surface 34, vertical sides 36, and horizontal support bars 38 together.

Each wing assembly 12 pivotally connects to opposing sides of the base 14 at attachment points 44. Each wing assembly 12 may further include an inner section 46 pivotally connected to an outer section 48 at additional attachment points 44, as shown in FIG. 1. The attachment points 44 secure each wing assembly 12 to the base 14 and each inner section 46 to the associated outer section 48 while still allowing pivotal movement between the respective components. The attachment points 44 may include rivets, bolts, hinges, or other suitable structure for permitting pivotal movement between the respective components.

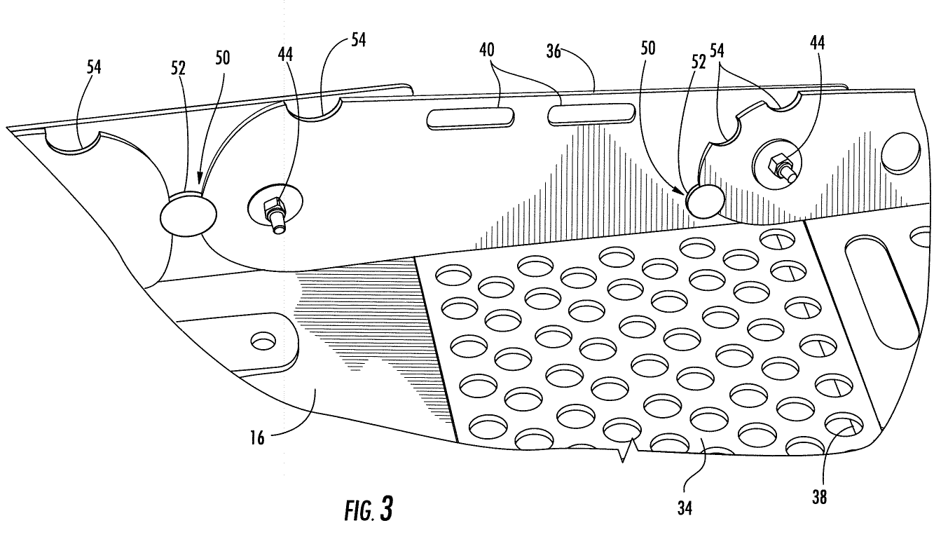

FIG. 3 provides a close-up view of the attachment points 44 shown in FIG. 1. The attachment points 44 may use rivets, bolts, hinges, slides, or other suitable substitutes. In alternate embodiments, the attachment points 44 may be located on other parts of the wing assembly 12, such as on the underside of the flat surface 34 and/or on the horizontal support bars 38.

As shown in FIG. 3, the attachment points 44 may include locking mechanisms 50 for securing the wing assemblies 12 in a desired position. The locking mechanisms 50 shown in FIG. 3 include spring-biased buttons 52 that fit into detents 54 in the vertical sides 36 corresponding to desired positions for the wing assemblies 12. To move the wing assembly 12 to another desired position, one simply depresses the button 52 to disengage the button 52 from the detent 54. The wing assembly 12 can then pivot to another desired position where the spring-biased button 52 again engages with the detent 54. Alternate embodiments may include other suitable mechanisms, such as a ratchet wheel, for locking the wing assemblies in various positions.

FIGS. 1, 4, and 5 illustrate one embodiment of the present invention with the wing assemblies 12 in various positions. FIG. 1 shows the cargo carrier 10 in an extended position, as it would be when installed on a vehicle. The extended position provides the maximum surface area on the cargo carrier 10 for carrying cargo. In the extended position, the locking mechanism 50 secures the wing assembly 12 horizontally and substantially co-planar with the base 14. The outer section 48 of the wing assembly 12, if present, may be similarly locked in a horizontal position.

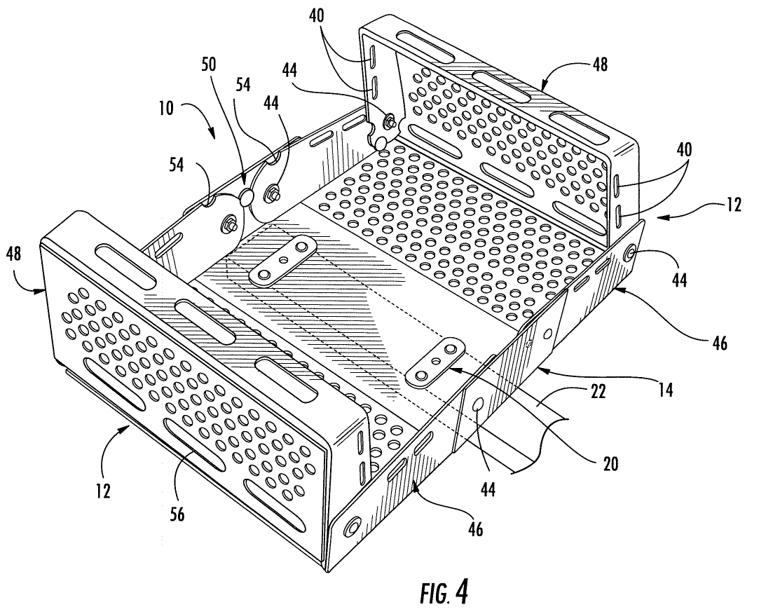

FIG. 4 shows the carrier 10 in an intermediate position. The intermediate position may be useful to prevent the cargo from shifting or sliding on the cargo carrier 10 while in transport. In the intermediate position, the outer section 48 of each wing assembly 12 pivots to a vertical position, substantially perpendicular to the base 14, and the locking mechanisms 50 secure the outer sections 48 of the wing assemblies 12 in the intermediate position.

FIG. 5 shows the cargo carrier 10 in a retracted position, as it would be when installing or removing the cargo carrier 10 or when the cargo carrier 10 is being stored. In the retracted position, the outer section 48, if present, pivots completely into the inner section 46, and the inner section 46 pivots to a vertical position, substantially perpendicular to the base 14. The locking mechanisms 50 may secure the outer section 48 and/or inner section 46 in the retracted position. As shown in FIG. 5, suitably sized apertures 56 in the outer sections 48 serve as convenient handles for carrying the cargo carrier 10 in the retracted position.

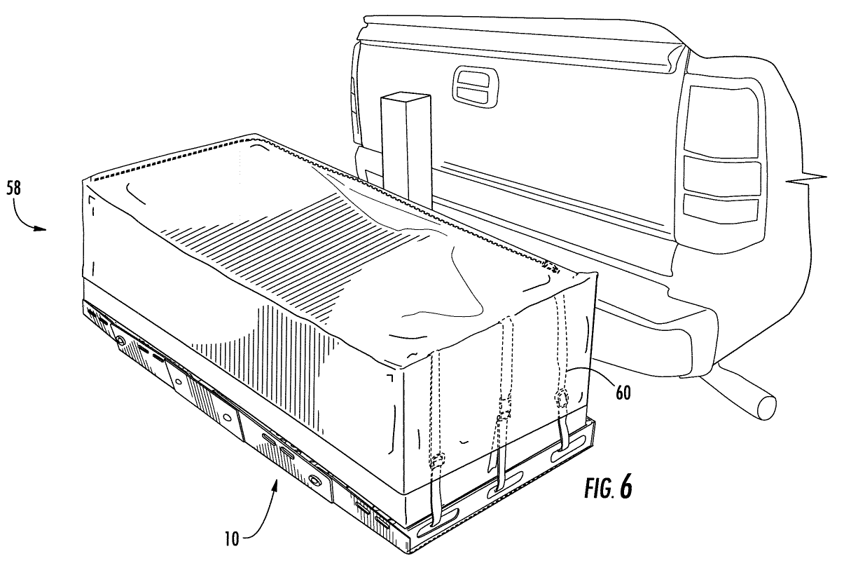

FIG. 6 shows the cargo carrier 10 in the extended position with a cargo bag 58 used in conjunction with the cargo carrier 10. The cargo bag 58 protects the cargo from the elements, such as wind, rain, and snow. In some embodiments, the cargo bag 58 can be an insulated bag for keeping cargo hot or cold. In other embodiments, the cargo bag 58 may be sized to also serve as a carrying or storage bag for the cargo carrier 10 when the cargo carrier 10 is in the retracted position.

The cargo bag 58 may attach to the cargo carrier 10 using various devices known in the art. For example, the cargo bag 58 may include straps 60 that secure the cargo bag 58 to the cargo carrier 10, as shown in FIG. 6. The straps 60 may include snaps, hook and loop fasteners, clips, clamps, or the like, to secure the cargo bag 58 to the cargo carrier 10. Locating the straps 60 at corners of the cargo bag 58 holds the cargo bag 58 in an expanded posture to facilitate loading and unloading.

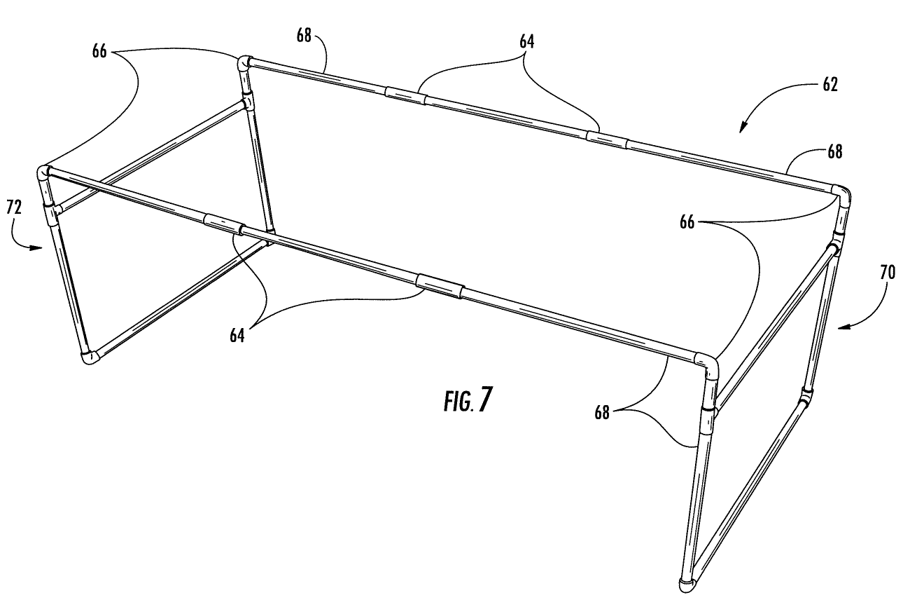

FIG. 7 provides a perspective view of an embodiment of a collapsible frame 62 that may be used with the cargo bag 58. The collapsible frame 62 may be installed inside the cargo bag 58 to provide a portable structure to support the shape of the cargo bag 58. The collapsible frame 62 may include fittings 64, 66 and tubing 68 configured to form a generally rectangular framework with horizontal extensions and vertical ends 70, 72. The fittings 64, 66 and tubing 68 may be made of aluminum, plastic, metal, or any suitable material, depending on the particular uses and needs.

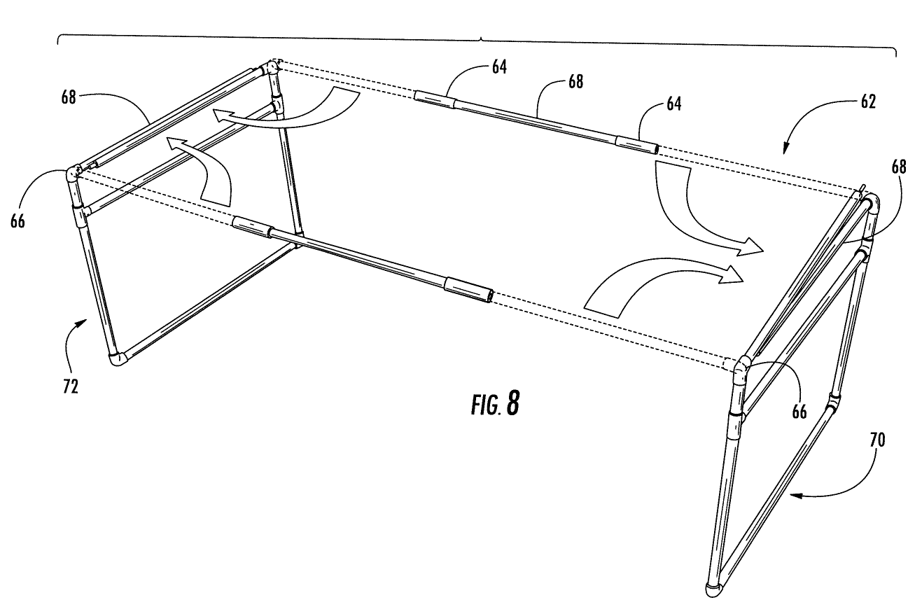

FIG. 8 provides a perspective view of the collapsible frame 62 shown in FIG. 7 in the collapsed position. As shown, the horizontal extensions 68 are withdrawn from the fittings 64. The fittings 66 in the vertical ends 70, 72 permit the horizontal extensions 68 to pivot to become coplanar with the vertical ends 70, 72. In some embodiments, the cargo bag 58 may include pockets on the inside of each end of the cargo bag for holding the vertical ends 70, 72. When collapsed, the withdrawn horizontal extensions 68, fittings 64, and vertical ends 70, 72 may be stored in the pocket in the cargo bag 58. This allows the cargo bag and collapsible frame to be conveniently folded up into a smaller volume for storage and transportation.

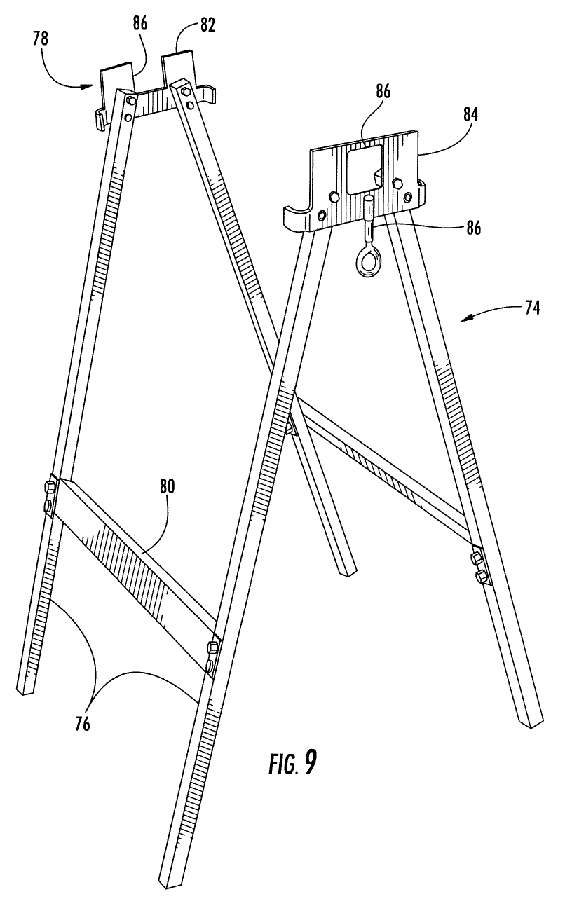

FIG. 9 provides a perspective view of an embodiment of a stand 74 that may be used in conjunction with the cargo carrier 10 to form a portable table. The stand 74 may be made of aluminum, plastic, metal, or any suitable material, depending on the particular uses and needs.

As shown in FIG. 9, the stand 74 generally includes a plurality of legs 76 pivotally connected to an attachment structure 78. The pivotal connection between the legs 76 and attachment structure 78 permits the stand 74 to collapse for more convenient and less bulky transport and handling. The stand 74 may further include one or more cross-braces 80 to provide additional stability to the legs 76. The specific configuration of the stand 74 is not critical to the present invention, and one of ordinary skill in the art can readily configure multiple equivalent structures that would provide suitable substitutes. For example, equivalent stands within the scope of the present invention may include more or less than four legs, with or without cross-braces. Similarly, the legs may be pivotally connected to the attachment structure using pins, ratchets, bearings, or other suitable devices. Alternatively, the legs may be fixedly connected to the attachment structure, depending on the particular design and use.

The attachment structure 78 shown in FIG. 9 generally includes an open receiver 82, a closed receiver 84, and a clamp 86. The open receiver 82 and closed receiver 84 may include openings sized and shaped to match the drawbar 22 of the cargo carrier 10. The clamp 86 may be a threaded screw, bolt, vice, or other device capable of applying force to the drawbar 22 to hold the drawbar in place.

Although the clamp 86 is shown on the closed receiver 84 in FIG. 9, alternate embodiments within the scope of the present invention may include a clamp on the open receiver 82 in addition to or in place of the clamp 86 on the closed receiver 84. In addition, one of ordinary skill in the art can readily configure multiple equivalent structures that would provide suitable substitutes to the attachment structure 78 shown in FIG. 9. For example, alternate embodiments of the attachment structure within the scope of the present invention may include one or more clamps, vices, bolt assemblies, or other mechanical devices for attaching and holding components together.

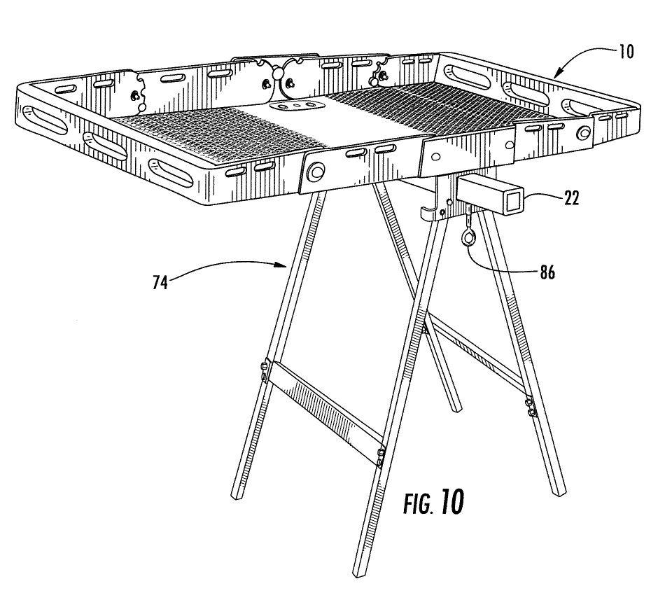

FIG. 10 provides a perspective view of the cargo carrier 10 depicted in FIG. 1 installed on the stand 74 depicted in FIG. 9 to form a portable table. As shown, the drawbar 22 fits through the closed receiver 84 and into the open receiver 82 (not shown). The clamp 86 holds the drawbar 22 in place. In this manner, the cargo carrier 10, with or without the cargo bag 58, can be used to transport various cargo, including possibly the stand 74, to a location. Once at the location, the stand 74 can be set up, and the cargo carrier 10 can be removed from the vehicle and installed on the stand 74 to provide a portable table for use, for example, in tailgating or camping.

It should be appreciated by those skilled in the art that modifications and variations can be made to the embodiments of the invention set forth herein without departing from the scope and spirit of the invention as set forth in the appended claims and their equivalents.

What is claimed is:

1. A portable table, comprising:
a. a cargo carrier for a vehicle, the cargo carrier comprising:
i. a base defining a planar carrying surface;
ii. a first wing moveably connected to said base and having a retracted position that occupies a smaller volume than an extended position;
iii. wherein the cargo carrier is configured to carry cargo when the first wing is in the extended position;
b. a stand removably connected to the cargo carrier.

2. The portable table of claim 1, wherein the cargo carrier further includes a second wing moveably connected to the base and opposite the first wing, wherein the first and second wings are on opposing sides of the base.

3. The portable table of claim 2, wherein the first and second wings each comprise:
a. an inner section proximate to the base, and
b. an outer section moveably attached to the inner section and separated from the base by the inner section in the extended position.

4. The portable table of claim 3, wherein for at least one of the first and second wings, the outer section resides within the inner section in the retracted position.

5. The portable table of claim 1, wherein the base includes a locking mechanism for locking the first wing in the retracted position.

6. The portable table of claim 1, wherein the stand includes a closed receiver.

7. The portable table of claim 1, further including a cargo bag removably attached to the cargo carrier.

8. The portable table of claim 7, wherein the cargo bag includes a collapsible frame.

9. A combined cargo carrier for a vehicle and portable table, comprising:
a. a base;
b. a first wing moveably connected to said base;
c. a second wing moveably connected to said base and opposite said first wing;
d. wherein each of said first and second wings has an extended position and a retracted position;
e. wherein said cargo carrier is configured to be extendable substantially perpendicular to the length of the vehicle; and
f. a stand removably connected to at least one of said base, said first wing, or said second wing.

10. The combined cargo carrier for a vehicle and portable table of claim 9, wherein said first and second wings are transverse to said base in said retracted position.

11. The combined cargo carrier for a vehicle and portable table of claim 9, wherein said cargo carrier occupies a smaller volume when at least one of said first or second wings is in said retracted position than when both said first and second wings are in said extended position.

12. The combined cargo carrier for a vehicle and portable table of claim 9, wherein said stand includes a closed receiver.

13. The combined cargo carrier for a vehicle and portable table of claim 9, further including a cargo bag removably attached to said cargo carrier.

14. The combined cargo carrier for a vehicle and portable table of claim 13, wherein said cargo bag includes a collapsible frame.

15. A portable table, comprising:
a. a cargo carrier for a vehicle, the cargo carrier comprising:
i. a base;
ii. a first wing moveably connected to the base and having an extended position, a partially retracted position, and a retracted position;
iii. wherein the cargo carrier occupies a smaller volume when the first wing is in the retracted position than when the first wing is in the extended position; and
b. a stand removably connected to the cargo carrier.

16. The portable table of claim 15, wherein the first wing is transverse to the base in the retracted position.

17. The portable table of claim 15, wherein the cargo carrier further includes a second wing moveably connected to the base and opposite the first wing.

18. The portable table of claim 15, wherein the stand includes a closed receiver.

19. The portable table of claim 15, further including a cargo bag removably attached to the cargo carrier.

20. The portable table of claim 19, wherein the cargo bag includes a collapsible frame.
